(19) United States
(12) Patent Application Publication
(10) Pub. No.: US 2012/0071142 A1
(43) Pub. Date: Mar. 22, 2012

(54) GENERATION OF MULTI-MEDIA RINGTONES FROM A FRIEND'S RECENT SOCIAL DATA

(76) Inventors: Jonathan William MEDVED, Jerusalem (IL); David Elliot GOLDFARB, Bet Shemesh (IL); Eshed DONI, Or Yehuda (IL)

(21) Appl. No.: 13/244,955

(22) Filed: Sep. 26, 2011

Related U.S. Application Data
(63) Continuation-in-part of application No. 13/014,805, filed on Jan. 27, 2011.
(60) Provisional application No. 61/298,933, filed on Jan. 28, 2010.

(51) Int. Cl. H04W 68/00

(52) U.S. Cl. 455/414.1

(57) ABSTRACT

A communications device includes a receiver to receive social data of a friend of a user of the communications device and an animator to animate the social data for playing on the communications device upon an occasion of a communications related triggering event between the user and the friend.

### CROSS-REFERENCE TO RELATED APPLICATIONS

This application is a continuation-in-part application of U.S. patent application Ser. No. 13/014,805, filed Jan. 27, 2011, which application claims benefit from U.S. Provisional Patent Application No. 61/298,933, filed Jan. 28, 2010, both of which applications are hereby incorporated by reference in their entirety.

### FIELD OF THE INVENTION

The present invention relates to social networks generally and to generation of a multi-media ringtone from a friend's recent social data in particular.

### BACKGROUND OF THE INVENTION

Social networks, such as Facebook (http://www.facebook.com), typically allow users to post a collection of pictures, texts, video, audio, links and other media to represent what they are doing and what has caught their interest. The user's friends may react to these posts, either by commenting or by posting their own data. The data that the user posts about himself or herself on the social network as well as any piece of data posted by social friends of the user, whether about the user or that the social friends may want the user to see, may be termed “social data”. Social data may also be defined as any data about a user that a friend is allowed to access.

Social networks also allow users to grant access to the aforementioned social data to their friends on the same network, allowing them to read, watch and enjoy what is happening to each other. It will be appreciated that in order to view this data, the friends typically have to login to the social network. Without this volitional effort, they cannot see their friends' social data.

In order to make this social data more visible, users can register to receive emails anytime their friends “change their status” or otherwise add profile information, posts, comments, etc.

Recently, some mobile handset manufacturers and operators have made users' social data (a collection of their most recent posts of any kind) visible on the handset “home screen”. Notable examples are Motorola's MotoBlur (http://www.motorola.com/Consumers/US-EN/Consumer-Product-and-Services/MOTOBLUR/Meet-MOTOBLUR) and Vodafone's Vodafone 360 Live (http://www.vodafone.com/content/index/press/group_press_releases/2009/360.html).

These systems use the handset home screen to present key elements of the social data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a novel multi-media ringtone generation and distribution system 100, constructed and operative in accordance with a preferred embodiment of the present invention;

FIG. 2 is a schematic illustration of the system of FIG. 1 with a polling server, constructed and operative in accordance with an alternative preferred embodiment of the present invention; and

FIG. 3 is a schematic illustration of an alternative embodiment of the distribution system of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The prior art has several disadvantages when viewing a user's social data. For example, as disclosed hereinabove, the friends may typically have to proactively login to the social network to view the social data of another friend. Even then, there may be additional issues to deal with. Depending on the view selected, different social data may be displayed together as a single amalgamated stream. Alternatively, the friends may have to search for a particular set of social data by selecting a particular user of interest. It will be appreciated that it is not uncommon for a user to have hundreds and even thousands of friends. In such circumstances, keeping track of the social data of individual friends may be an extremely daunting task.

The solutions provided by mobile handset manufacturers and operators may also be problematic. Simultaneous presentation of individual social data may suffer from the size constraints of a typical mobile display. Amalgamated streams may be difficult to follow, and presentation of multiple friends' social data may take too long, or be too confusing. A handset's home screen is generally not large enough to display multiple social data sets, representing all of a user's friends. Instead, selections must be made, showing only some events, typically the most recent, of a small handful of friends.

Applicant has realized that users may be interested in seeing the social data of different friends at different times. Applicant has also realized that users may prefer to see a friend's social data at the start of a communication event with that friend. Accordingly, it may be advantageous to associate the display of data originated from a friend's social network with a call occurring between the user and the friend. For example, when a friend calls a user, the user may view an extract from the friend's social data on the display of a user's communication device.

U.S. Pat. No. 7,761,816, assigned to the common assignee of the present invention and hereby incorporated in its entirety by reference, defines a video ringtone in which the video clip is chosen by the calling party, to be displayed on the called handset. U.S. Pat. No. 7,761,816 also discloses a community server that may facilitate the distribution of a user's selected/provided video ringtone to his/her “friends”. U.S. patent application Ser. No. 11/768,989, also assigned to the common assignee of the present invention and also incorporated in its entirety by reference, describes methods for user-generation of video clips for the various types of ringtones. Applicant has realized that such a system may be utilized to share social data between friends to be viewed when either calls the other. This may enable the two participants to be updated on the postings of the other just as they are about to embark on a conversation.

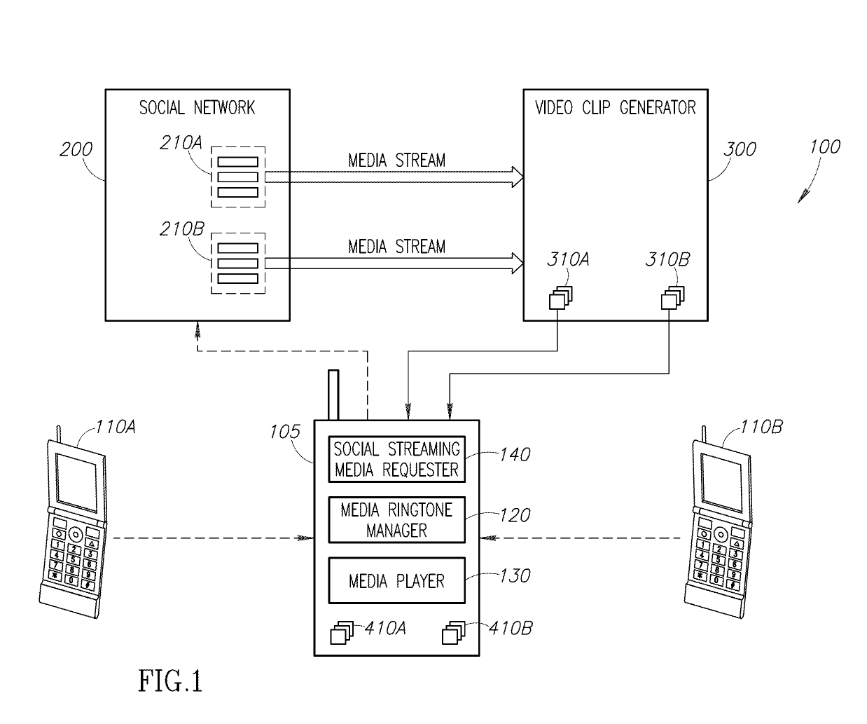

Reference is now made to FIG. 1, which illustrates a novel multi-media ringtone generation and distribution system 100, constructed and operative in accordance with a preferred embodiment of the present invention. System 100 may comprise a social network 200, a video clip generator 300 implemented on a server external to social network 200 and a communications device 105 belonging to a user of social network 200. Communications devices 110 may be used by friends of the user to communicate with device 105 and may be any type of communication device, which may include both communication elements and media playing elements and may include any type of cellular phone with a display.

Communications device 105 may comprise a media ringtone manager 120 and a media player 130. Manager 120 may facilitate the playing of media ringtones on media player 130 in response to communications triggering events associated with the user's friends, such as those using devices 110. Manager 120 may function in a generally analogous manner to the method and system disclosed in U.S. Pat. No. 7,761,816 and U.S. patent application Ser. No. 11/768,989; however it will be appreciated that the invention may include any such suitable media ringtone management function.

Communications device 105 may also comprise social data requester 140. Social data requester 140 may, as will be described hereinbelow, initiate and/or control a process for converting a friend's social data to a media ringtone to be associated with that particular friend. In accordance with a preferred embodiment of the present invention, social data requester 140 may be configured to initiate this process on a periodic basis. Alternatively, the user may activate requester 140 on demand.

Social network 200 may have stored social data 210 associated with friends of user 10. It will be appreciated that social data 210 may comprise at least one of a variety of types of media content, such as images, text, video clips, audio clips, data/application files, web links, etc. Requester 140 may forward a request to social network 200 for social data associated with friends of the user of device 105 to be forwarded to, or read by, video clip generator 300. In an exemplary preferred embodiment of the present invention, social data 210A may be associated with the friend using communications device 110A; social data 210B may be similarly associated with the friend using device 110B.

It will be appreciated that social network 200 may typically have available application programmer interfaces (APIs) that may enable third-party developers to access and manipulate social data on behalf of a user. For example, the APIs for Facebook may be available at http://developers.facebook.com/. These APIs may typically allow an application to access the user's profile data as well as whatever social data is associated with the user (whether created by the user or contributed by the user's friends). Thus, an application such as requester 140 may request the social data associated with the user as it would normally be presented to the user by social network 200. Security issues and filtering may typically be handled by social network 200. It will be appreciated that additional filtering may also be implemented within the context of the present invention, to meet the needs of presentation, formatting, privacy, or any other criteria.

Video clip generator 300 may be any suitable application or service for the generation of a video clip from a social data. For example, Animoto, available at http://animoto.com/, may be used to generate video clips from social data of individual images, music, and text. Video clip generator 300 may generate video clips 310 for download to device 105 as multi-media ringtones 410, on behalf of the user of device 105.

Accordingly, as per the exemplary embodiment illustrated in FIG. 1, requester 140 may initiate the generation of video clip 310A from social data 210A associated with the user's friend that may be associated with device 110A. Video clip 310A may be downloaded for use on device 105 as media ringtone 410A. Upon the occasion of a communications triggering event involving device 110, media player 130 may play associated media ringtone 410A. Similarly, if a communications triggering event may involve device 110B, media ringtone 410B may be played.

It will be appreciated that communication devices 110 may be any suitable devices for communicating with device 105. Accordingly, it will be appreciated that devices 110 may or may not be configured in a similar manner as device 105. The present invention may also include embodiments wherein the friends associated with social data 110 may also be using devices 105. Similarly, it will be appreciated that the embodiment depicting a user with two friends is exemplary; system 100 may be configured to process any relevant number of friends.

It will further be appreciated that in accordance with the disclosed prior art, a friend or “buddy” of a user may typically select/provide a media clip and “push” it to the user on whose device it may eventually be played as a media ringtone. In contrast, the present invention may disclose a method for a user to “pull” content about the friend/buddy without proactive selection/provision of a media clip by the friend/buddy. The only action required by the friend/buddy may be to grant access to the relevant social network piece of information to his friend or buddy within the context of social network 200.

In accordance with an alternative preferred embodiment of the present invention, video clip generator 300 may be replaced (or alternatively, augmented) by a photo montage tool that may generate a photo montage comprising multiple photos and/or texts to be displayed all at the same time. A tool such as ImageMagick, available at http://www.imagemagick.org, may be used, for example, to generate the montage.

In accordance with another alternative preferred embodiment, social data requester 140 may be implemented as a module on a community server for media sharing, such as the community server disclosed in U.S. patent application Ser. Nos. 11/544,938 and 11/768,989, both assigned to the common assignee of the present invention and both incorporated herein by reference. The user of device 105 may access this module to configure preferences for the downloading of media ringtones. In accordance with an alternative embodiment of the present invention, video clips 310 may be temporarily stored on such a community server prior to their distribution to device 105 as disclosed in U.S. patent application Ser. Nos. 11/544,938 and 11/768,989.

In accordance with a preferred embodiment of the present invention, in order to distinguish the “ringing” device as belonging to user 10, the user may elect to define an audio track to be played in parallel with multi-media ringtone 410. The audio and video social data may be played simultaneously on device 105 or they may be combined into a single audio-visual clip by video clip generator 300.

In accordance with a preferred embodiment of the present invention, the multi-media ringtone may also be implemented as any other tone of the mobile device, such as a ringback tone played to the caller, tone played at the end of call, SMS arrival tone signifying the arrival of a text message, etc.

In accordance with a preferred embodiment of the present invention, video clip generator 300 may be included as a module on a server, such as the community server disclosed in U.S. patent application Ser. Nos. 11/544,938 and 11/768,989.

In accordance with a preferred embodiment of the present invention, requester 140 may be configured to download to and cache media ringtones 410 on device 105 at regular time intervals.

Some social networks 200 may have functionality for automatically notifying a user regarding changes in a friend's social data 210. In such a case, social network 200 may configured to “push” notification of a change to device 105 via any suitable means, such as, for example, SMS, TCP, or platform-specific services, such as, for example, Apple Push Notification Service on iPhones.

In accordance with a preferred embodiment of the present invention, requester 140 may be configured to poll social data 210 on a frequent basis to catch any changes in a friend's social data 210 and to initiate the generation of a new multi-media ringtone 310 for download to device 105 as multi-media ringtone 410 whenever a change is detected in a social data 210.

It will be appreciated that frequent polling may be problematic on a battery operated device or resource-constrained device, such as device 105.

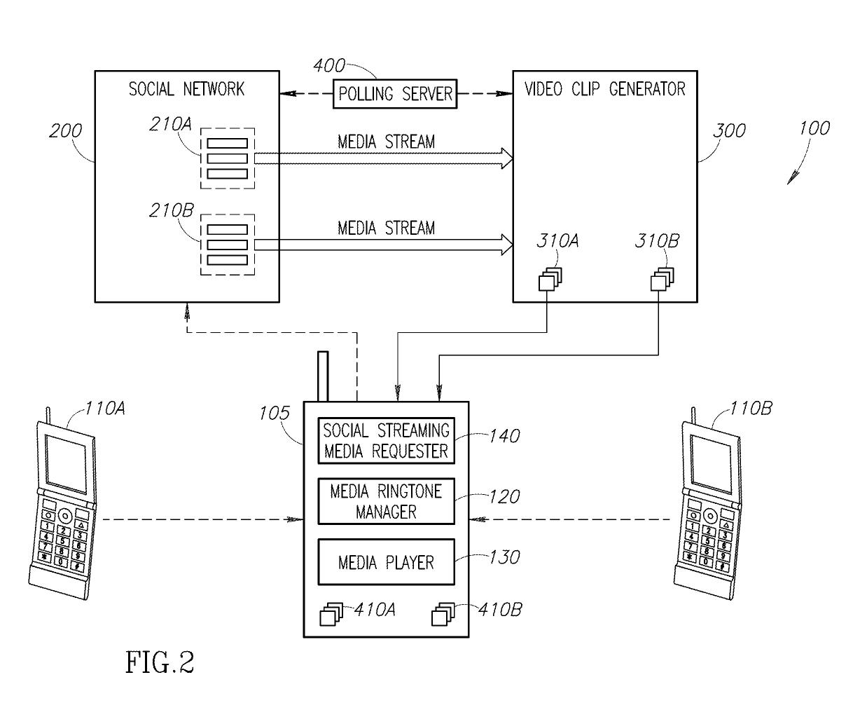

Reference is now made to FIG. 2. In accordance with a preferred embodiment of the present invention, system 100 may be configured with a polling server 400 that may act on behalf of the user of device 105 to periodically poll social network 200 for changes in social data 210. When such changes may be detected, polling server 400 may alert generator 300 to begin the generating an updated version of multi-media ringtone 310 as discussed hereinabove. Alternatively, polling server 400 may send notify requester 140, after which requester 140 may initiate generation of multi-media ringtones 310/410 as described hereinabove. It will be appreciated that polling server 400 may be implemented in combination with, or separately from, generator 300.

Upon receipt of a notification from the social network or polling server, requester 140 may then initiate the generation of a new multi-media ringtone 410 as discussed hereinabove.

In accordance with a preferred embodiment of the present invention, multi-media ringtone 410 may be requested and generated in real-time as part of the start of the call handling process on device 105. This may be done directly by the process implementing the call-handling ringtone, or an asynchronous request may trigger social data media requestor 140. The request response, when it arrives, may replace or augment the ongoing ringtone. It will be appreciated that the user receiving the incoming call may typically be unaware of its existence before a ringtone may start to play. Accordingly, a slight delay, that may be necessary in order to generate and download the requested ringtone, may be unnoticed by the user. Alternatively, a default or previously generated ringtone may be played immediately and the newly generated ringtone may then replace or augment it.

The request response may even arrive after the ringtone has completed or the call has been answered. In accordance with a preferred embodiment of the present invention, the social data may be played silently on the screen during the call conversation.

In accordance with a preferred embodiment of the present invention, multi-media ringtone 410 may be streamed to device's 110 during call-handling, or during the call conversation or at any other suitable time, and may be played from the streaming input, rather than being pre-cached.

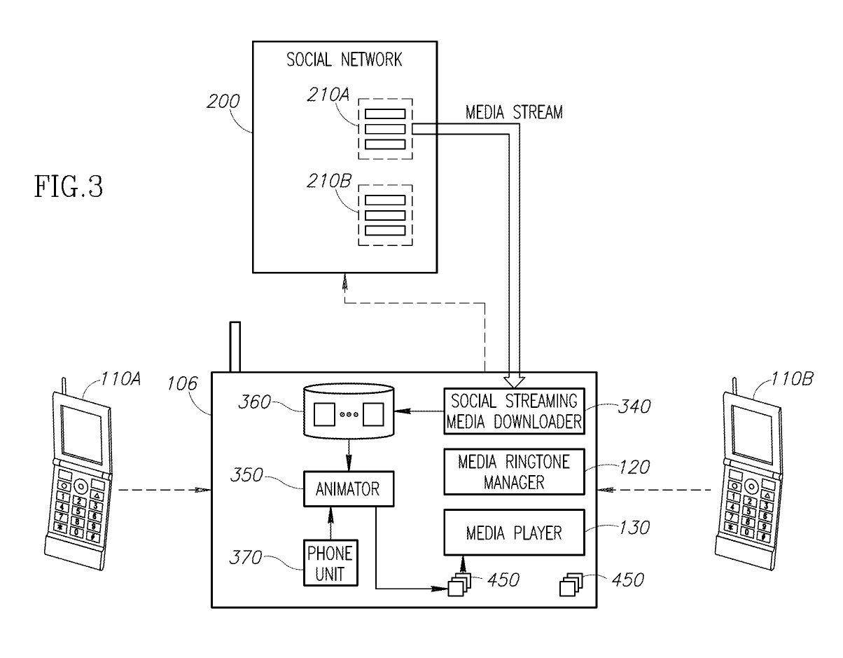

In accordance with a preferred embodiment of the present invention and as shown in FIG. 3 to which reference is now made, a video clip generator may be implemented as a social data animator 350 on the device, here labeled 106. Social data animator 350 may be implemented as part of the software of device 106 or as a downloadable application.

In this embodiment, the media requestor is a social streaming media downloader 340, which may not only request the social data, similar to media requester 140, but may download it to device 106 and may store it in a storage unit 360 with an association with the contact or friend to whom the social data belongs. In this embodiment, the stored content is not a multi-media ringtone. Rather, it is a sequence of still images or text, which is rendered into a multi-media ringtone, as a slide show or ersatz video, on-demand. The stored content may include audio and/or transition information. The result of this embodiment may be a significantly faster and much less expensive download.

Animator 350 may be any suitable animator, which may be implementable on a communication device. For example, it may utilize the mobile phone version of PowerPoint, commercially available from Microsoft, with which it may create a slideshow from the downloaded social data, such as images, text etc., which may act as “slides”. Alternatively, animator 350 may be a leaner application designed to “animate” the downloaded social data (i.e. to smoothly and interestingly change from one data element of the social data to the next).

Importantly, the present embodiment may generate the multi-media ringtone “on-the-fly”, when a phone call comes in or is requested. Thus, in this embodiment, the phone unit, labeled 370, may activate social data animator 350 when a phone call to a contact is requested or when a phone call from a contact is received or at any other time related to a call with a contact. Phone unit 370 may provide the contact information to social data animator 350 and social data animator 350 may retrieve the contact's social data from storage unit 360. If desired, social data animator 350 may also retrieve an audio clip to be used in the resultant multi-media ringtone.

Social data animator 350 may then animate the “slides”, which may involve displaying each slide for a period of time and then transitioning from one slide to another, usually accompanied by an audio clip. Social data animator 350 may display its output, which may be an animated ringtone 450, on media player 130, and may continue to animate the social data during the call setup period. In general, the animation may occur “on-the-fly”; however, social data animator 350 may generate the animations previously and may store them (i.e. may store the transitioning information with the “slides”). In this latter embodiment, social data animator 350 may play the animation during the call setup period.

It will be appreciated that social data animator 350 may operate on images, posts, news flashes or any other information available from a social network that may come as a social data element (i.e. as a unit of information), such as the fact that it is your birthday today. It may also animate stock quotes, internet searches, location information, etc.

It will further be appreciated that media downloader 340 may download the social data at any time, when activated by the user of the device or when the user indicates a contact or periodically, etc. However, animated ringtones 450 may be generated only when a phone call with the particular contact may occur. Thus, it is possible that the social data may be updated without the user's knowledge and the latest data may become part of animated ringtone 450, thereby enabling the user to see what the latest news of his friend or contact is just before talking to him/her. This may enable the user to stay abreast of a friend's activity without the need to review all the posts of all of his friends on a daily basis but rather, just before communicating with a particular friend.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method implementable in software, the method comprising:
receiving social data of a friend of a user of a communications device; and
animating said social data for playing on said communications device upon an occasion of a communications related triggering event between said user and said friend.

2. The method according to claim 1 wherein said social data is accessible to said user via a social network.

3. The method according to claim 1 and also comprising previously associating said social data of a friend with said friend's contact information.

4. The method according to claim 1 and wherein said animating comprises animating said social data as an animated ringtone.

5. The method according to claim 1 and also comprising previously downloading said social data.

6. The method according to claim 5 and wherein said previously downloading also comprises:
accessing said social data from said social network without input from said user.

7. The method according to claim 6 and also comprising:
periodically performing said accessing; and
storing said received social data on said user's communication device.

8. The method according to claim 1 and wherein said triggering event is at least one of an incoming call, an outgoing call, an ongoing call, an end of a call, and an SMS alert.

9. The method according to claim 1 and wherein said animating comprises producing a slide show from said social data.

10. The method according to claim 1 and wherein said social data comprises at least one of images, text and facts.

11. A communications device comprising:
A receiver to receive social data of a friend of a user of said communications device; and
An animator to animate said social data for playing on said communications device upon an occasion of a communications related triggering event between said user and said friend.

12. The communications device according to claim 11 wherein said communications device comprises a modem to access said social data via a social network.

13. The communications device according to claim 11 and also comprising a contact list in which to previously associate said social data of a friend with said friend's contact information.

14. The communications device according to claim 11 and wherein said animator comprises a unit to provide said animated social data to a media player as an animated ringtone.

15. The communications device according to claim 11 and also comprising a downloader to previously download said social data.

16. The communications device according to claim 15 and wherein said downloader comprises:
A unit to access said social data from said social network without input from said user.

17. The communications device according to claim 16 and also comprising:
An activator to periodically perform said accessing; and
A storage unit to store said received social data on said user's communication device.

18. The communications device according to claim 11 and wherein said triggering event is at least one of an incoming call, an outgoing call, an ongoing call, an end of a call, and an SMS alert.

19. The communications device according to claim 11 and wherein said animator comprises a slide show generator to produce a slide show from said social data.

20. The communications device according to claim 11 and wherein said social data comprises at least one of: images, text and facts.
